(19) United States
(12) Patent Application Publication
(10) Pub. No.: US 2024/0234118 A9
(43) Pub. Date: Jul. 11, 2024

(54) ION SOURCE NEBULISER

(71) Applicant: Micromass UK Limited, Wilmslow (GB)

(72) Inventors: Alastair Booth, Glossop (GB); Ian Trivett, Cheadle (GB); Anthony Hesse, Stockport (GB); Mark Walford, Wilmslow (GB); David Gordon, Middlewich (GB); Haydn Murray, Stockport (GB); Stephen Aryton, Bradford (GB)

(73) Assignee: Micromass UK Limited, Wilmslow (GB)

(21) Appl. No.: 18/546,528

(22) PCT Filed: Feb. 15, 2022
(86) PCT No.: PCT/GB2022/050399

§ 371 Date: Aug. 15, 2023

(30) Foreign Application Priority Data
Feb. 15, 2021 (GB) 2102102.7

(51) Int. Cl. H01J 49/04; H01J 49/16

(52) U.S. Cl. CPC H01J 49/045; H01J 49/0404; H01J 49/167

(57) ABSTRACT

A nebuliser comprises an outlet aperture and a liquid capillary. A method of operating the nebuliser comprises supplying a gas to the outlet aperture, measuring a flow rate of the gas supplied to the outlet aperture, and determining a position of the liquid capillary relative to the outlet aperture based on the measured flow rate.

### CROSS-REFERENCE TO RELATED APPLICATION

This application claims priority from, and the benefit of, United Kingdom patent application No. 2102102.7 filed on 15 Feb. 2021. The entire contents of that application is incorporated herein by reference.

### FIELD OF THE INVENTION

The present invention relates generally to ion sources and in particular to nebulisers for ion sources.

### BACKGROUND

Ionisation techniques such as Electrospray Ionisation (ESI) utilise a nebuliser to generate a spray of droplets. Typically, a liquid capillary is arranged coaxially with respect to an outlet aperture of the nebuliser. A flow of liquid supplied to the liquid capillary is nebulised by a nebulising gas flow supplied to the outlet aperture.

In ion source nebulisers, the position of the outlet of the liquid capillary relative to the nebuliser outlet aperture can significantly affect the properties of the nebulised spray.

In this regard, the Applicant has previously designed a mechanism for controlling the position of the capillary relative to the nebuliser outlet aperture (as described for example in GB 2549389 A1 (Micromass UK Ltd), the entire content of which is incorporated herein by reference). As described in GB 2549389 A1, the position of the capillary relative to the outlet aperture can be optimised during an experiment by detecting ions using an analytical instrument, and adjusting the position using the mechanism until a maximum ion signal intensity is achieved.

Although this technique can successfully result in the position being optimised under a wide range of circumstances and for a wide range of experiments, the Applicant believes that there remains scope for improvements to methods of operating ion sources nebulisers.

### SUMMARY

According to an aspect, there is provided a method of operating a nebuliser that comprises an outlet aperture and a liquid capillary, the method comprising:
supplying a gas to the outlet aperture;
measuring a flow rate of the gas supplied to the outlet aperture; and
determining a position of the liquid capillary relative to the outlet aperture based on the measured flow rate.

Various embodiments are directed to a nebuliser for an ion source, such as an Electrospray Ionisation (ESI) ion source, a Desorption Electrospray Ionisation (DESI) ion source, a Desorption Electro-Flow Focusing Ionisation (DEFFI) ion source, an impactor ion source, or an Atmospheric Pressure Chemical Ionisation (APCI) ion source.

In sensitive analytical techniques that utilise an ion source comprising a nebuliser, such as mass and/or ion mobility spectrometry, it is desirable for the properties of the nebulised spray produced by the nebuliser to be precisely controllable and reproducible. It has been found that the position of the liquid capillary relative to the nebuliser outlet can significantly affect the properties of the nebulised spray, and so it is desirable to configure the nebuliser in such a way that the position of the liquid capillary relative to the nebuliser outlet is precisely controllable and reproducible. As will be described in more detail below, this is particularly the case for so-called “flow blurring” nebulisers.

Precise control of the liquid capillary position may be needed where, for example, it is desired to operate the nebuliser with different capillary positions. Even where it is desired to (always) operate the nebuliser with the same, fixed capillary position, manufacturing imperfections (e.g. between different liquid capillaries and/or different nebuliser outlets, etc.), temperature changes, and so on, mean that it is desirable to have control over the position, so that the position can be set or optimised before or during set-up of the analytical instrument and/or intermittently thereafter.

In this regard, the Applicant has previously designed a mechanism for controlling the position of the capillary relative to the nebuliser outlet (as described for example in GB 2549389 A1 (Micromass UK Ltd), the entire content of which is incorporated herein by reference). As described in GB 2549389 A1, the position can be optimised during an experiment by detecting ions using the analytical instrument, and adjusting the position using the mechanism until a maximum ion signal intensity is achieved.

Although this technique can successfully result in the position being optimised under a wide range of circumstances and for a wide range of experiments, the Applicant now believes that further improvements can be made, in particular in terms of accuracy and/or reproducibility.

This is because measurements of ion signal intensity can depend on a number of factors that are unrelated to the position of the liquid capillary relative to the outlet aperture (e.g. depending on the particular sample being analysed, other parameters of the nebuliser and/or the ion source, and/or the configuration of the analytical instrument). This means, for example, that the ion signal intensity may be maximum at different positions under different circumstances, such as where different ionic species are being measured, where the nebuliser is positioned and/or orientated differently with respect to an analytical instrument inlet, and so on. This in turn can make highly reproducible and precise control of the position challenging, in particular for inexperienced users, e.g. across different experiments and/or different instruments.

While it can be possible to directly measure the position of the liquid capillary relative to the nebuliser outlet, e.g. using a microscope, this is a relatively cumbersome, time-consuming and skilled task, and cannot be performed during an experiment. In addition, the position of the liquid capillary relative to the nebuliser outlet cannot be measured in this way for arrangements in which the outlet of the liquid capillary is withdrawn from the nebuliser outlet aperture, such as for so-called “flow blurring” nebulisers.

In accordance various embodiments, the position of the liquid capillary relative to the nebuliser outlet is measured indirectly by measuring the flow rate of the nebulising gas supplied to the nebuliser outlet.

In this regard, and as will be described in more detail below, the Applicant has recognised that such flow rate measurements can be used as a proxy for measurements of the position of the liquid capillary relative to the nebuliser outlet aperture. Such flow rate measurements have been found to provide an accurate and reproducible measure of this position.

Furthermore, the flow rate measurements are independent of factors that are unrelated to the position, such as being independent of the particular sample being analysed, other parameters of the nebuliser and/or the ion source, the configuration of the analytical instrument, and so on. This means that the position can be determined accurately and reproducibly in different circumstances, such as across different experiments and/or different instruments.

In addition, the use of a flow rate measurement to determine the position of the liquid capillary relative to the outlet aperture is a relatively straightforward task that can be accomplished by an inexperienced user, and so is particularly suited for use as part of a standard operating procedure defined for the ion source.

It may be possible to use an alternative property of the gas flow to determine a position of the liquid capillary, such as a measure of the pressure of the gas. However, the Applicant has recognised that compared with an alternative measured property, such as the pressure, a flow rate measurement can be particularly sensitive to changes in the position of the liquid capillary relative to the outlet aperture. For example, although there may be a change in pressure of the gas related to a change in the position of the liquid capillary, the change in pressure is relatively small for a given change in position and therefore a pressure based measurement would not be very sensitive.

Furthermore, a flow rate measurement may be performed using a flow rate controller that the nebuliser may comprise for controlling the flow rate of a gas in the nebuliser. Use of an alternative measured property, such as the pressure, may require an alternative component for measuring the pressure, such as a pressure gauge, which the nebuliser may then require in addition to a flow rate controller for controlling the flow rate.

It will be appreciated, therefore, that various embodiments provide an improved method of operating a nebuliser.

Determining the position of the liquid capillary relative to the outlet aperture based on the measured flow rate may comprise:
determining, based on the measured flow rate, a distance between an outlet of the liquid capillary and the outlet aperture in an axial direction that extends along a length of the nebuliser and/or along a length of the liquid capillary.

Determining the position of the liquid capillary relative to the outlet aperture based on the measured flow rate may comprise:
determining, based on the measured flow rate, either that (i) the liquid capillary is in a first position relative to the outlet aperture; or that (ii) the liquid capillary is other than in (is not in) the first position relative to the outlet aperture.

The method may comprise:
supplying the gas to the outlet aperture at a first pressure;
comparing the measured flow rate to a first flow rate, wherein the first flow rate is a flow rate that is indicative of the liquid capillary being in a first position relative to the outlet aperture when gas is supplied to the outlet aperture at the first pressure; and
determining that the liquid capillary is in the first position when the measured flow rate is approximately equal to the first flow rate; and/or
determining that the liquid capillary is other than in (is not in) the first position when the measured flow rate is unequal to the first flow rate.

The first position may be a desired position of the liquid capillary relative to the outlet aperture.

The first position may be a position of the liquid capillary relative to the outlet aperture that corresponds to flow blurring nebulisation.

The method may comprise:
when it is determined, based on the measured flow rate, that the liquid capillary is other than in (is not in) the first position, altering the position of the liquid capillary relative to the outlet aperture.

According to an aspect, there is provided a method of operating a nebuliser that comprises an outlet aperture and a liquid capillary, the method comprising:
supplying a gas to the outlet aperture;
measuring a flow rate of the gas supplied to the outlet aperture; and
altering the position of the liquid capillary relative to the outlet aperture based on the measured flow rate.

Altering the position of the liquid capillary relative to the outlet aperture may comprise:
altering a distance between an outlet of the liquid capillary and the outlet aperture in an axial direction that extends along a length of the nebuliser and/or along a length of the liquid capillary.

The method may comprise:
determining that the distance between the outlet of the liquid capillary and the outlet aperture is greater than a first distance when the measured flow rate is greater than a first flow rate; and/or
determining that the distance between the outlet of the liquid capillary and the outlet aperture is less than the first distance when the measured flow rate is less than the first flow rate; and/or
determining that the distance between the outlet of the liquid capillary and the outlet aperture is approximately equal to the first distance when the measured flow rate approximately equal to the first flow rate.

The method may comprise:
when it is determined, based on the measured flow rate, that the distance between the outlet of the liquid capillary and the outlet aperture is greater than the first distance, reducing the distance between the outlet of the liquid capillary and the outlet aperture; and/or
when it is determined, based on the measured flow rate, that the distance between the outlet of the liquid capillary and the outlet aperture is less than the first distance, increasing the distance between the outlet of the liquid capillary and the outlet aperture.

Determining the position of the liquid capillary relative to the outlet aperture may comprise determining, based on the measured flow rate, whether the position of the liquid capillary relative to the outlet aperture is stable.

The nebuliser may be configured such that an outlet of the liquid capillary is withdrawn within the nebuliser and/or other than protrudes (does not protrude) beyond the outlet aperture

The method may comprise supplying a liquid to the liquid capillary and nebulising the liquid using the nebuliser.

The method may comprise ionising the liquid.

The step of measuring the flow rate of the gas supplied to the outlet aperture may be performed using a (gas) flow meter.

The flow meter may be a mass flow meter, such as a thermal mass flow meter that may operates by, for example, measuring a temperature differential at different (upstream and downstream) positions of the gas flow and/or by measuring an amount of heat needed to be applied at a positon in the gas flow in order to maintain a particular temperature differential.

For example, the thermal mass flow meter may apply heat to one position that the gas flows past and measure a temperature differential between that position and another position that the gas flows past which is downstream with respect to where the heat is applied, wherein the temperature differential varies with the amount of heat that flows with the gas to the downstream position and is related to, and can be used to determine a measure of, the mass flow rate.

In another example, the thermal mass flow meter may control the temperature differential to be a particular value by varying the amount of heat that is applied to the upstream position (e.g. by varying the amount of power that is supplied to a resistive heater), wherein the amount of heat needed to maintain the particular temperature differential can be used to determine a measure of the flow rate.

Alternatively, a mechanical mass flow meter, such as a Coriolis mass flow meter, may be used. The mechanical mass flow meter may measure the mass flow rate according to an amount of movement or rotation (e.g. rate of rotation) of a component of the meter that varies with the mass flow rate.

The flow meter may form part of a gas flow controller (e.g. a thermal mass flow controller). Thus, the step of measuring the flow rate of the gas supplied to the outlet aperture may be performed using a gas flow controller that comprises a flow meter.

The method may comprise providing a gas flow controller having a gas flow meter, wherein the step of measuring the flow rate of the gas supplied to the outlet aperture comprises measuring the flow rate of the gas using the gas flow meter, and wherein the gas flow controller adjusts the flow rate of gas to the outlet aperture based on a gas flow rate measured by the gas flow meter.

For example, the gas flow controller may adjust the flow rate of gas to the outlet aperture until the gas flow rate measured by the gas flow meter reaches a predetermined target value.

Therefore, a single gas flow meter may be provided for the dual purpose of controlling the gas flow rate to the desired value, and also to determine the position of the liquid capillary relative to the outlet aperture.

It is particularly preferable for an ion source assembly to comprise a gas flow controller when it may be used in different modes of operation, which may require different rates and requirements for the flow of gas. For example, an ion source assembly may be configured, suitable and/or adaptable for use as plural ones of e.g., an Electrospray Ionisation (ESI) ion source, a Desorption Electrospray Ionisation (DESI) ion source, a Desorption Electro-Flow Focusing Ionisation (DEFFI) ion source, an impactor ion source, and/or an Atmospheric Pressure Chemical Ionisation (APCI) ion source. The nebuliser described herein may be used in all or some of these modes of operation.

The gas flow controller may be used and/or configured to control the flow rate of a gas supplied within the ion source assembly. When the ion source assembly utilises a nebuliser as described herein, the gas flow controller may control the flow rate of a gas supplied to the outlet aperture of the nebuliser. However, the gas flow controller may also be used to control the flow rate of a gas supplied to other components, such as when the nebuliser is modified or replaced in order for the ion source assembly to operate in a different manner.

The gas flow controller may use a feedback control process to control the flow rate of the gas by measuring the flow rate of the gas with a flow meter and adjusting the flow rate of the gas based on the measured flow rate. For example, the gas flow controller may comprise an orifice that the gas flow controller can change the size of, to thereby change the flow rate of a gas through the orifice, in response to a determined difference between a desired flow rate and a flow rate measured by the flow meter.

When a gas flow controller is present for controlling the flow rate and does comprise a flow meter, it is preferable that the same flow meter that is used for the control of the flow rate by the gas flow controller is also used for the determination of the position of the liquid capillary relative to the outlet aperture. However, these functions may be fulfilled using different flow meters (e.g. including a flow meter that does not form a component of the gas flow controller). When both functions are fulfilled using the same flow meter, the use of the flow meter for controlling the flow rate may be performed separately to the use of the flow meter for measuring a flow rate of the gas supplied to the outlet aperture in order to determine a position of the liquid capillary relative to the outlet aperture (at which point the gas flow controller may be used for measuring, but not altering, the flow rate).

For example, the gas flow controller may first be used to measure the flow rate for determining a position of the liquid capillary relative to the outlet aperture. Then, the flow controller may be used to set the flow rate of the gas to optimise the operation of the ion source (e.g. to optimise nebulisation of a liquid by the gas flow).

The gas flow controller may be configured and adapted for the flow meter to measure the flow rate while allowing for the flow rate to be independently varied (i.e. the gas flow controller may measure the flow rate while it is not operating to (try to) maintain the flow rate at a particular value). For example, when the gas flow controller is configured to control the flow rate based on the size of an orifice, the gas flow controller may maintain the orifice at a constant size while measuring the flow rate to determine (and/or adjust) a position of the liquid capillary relative to the outlet aperture.

Alternatively, a user may (or the apparatus may be configured to) measure a flow rate using the flow meter of a gas flow controller while allowing the flow rate to be independently varied without requiring the gas flow controller to be adapted specifically for this purpose. The flow rate may then be measured despite the gas flow controller trying to maintain the flow rate at a particular value, such as by setting a value for the flow rate that the gas flow controller will try to maintain but that it is not possible to maintain (e.g. setting the value above the maximum flow rate that the gas flow controller is able to maintain—which may, for example, cause the gas flow controller to maintain a maximum orifice size).

According to an aspect, there is provided a method of mass and/or ion mobility spectrometry, the method comprising:
producing ions by ionising a liquid sample using the method described above; and
analysing the ions.

According to an aspect, there is provided a nebuliser apparatus comprising:
a nebuliser comprising an outlet aperture and a liquid capillary, wherein the nebuliser is configured such that an outlet of the liquid capillary is withdrawn within the nebuliser, and wherein the apparatus is configured such that the position of the liquid capillary relative to the outlet aperture can be altered;
a gas supply configured to supply gas to the outlet aperture; and
a flow meter configured to measure a flow rate of the gas supplied to the outlet aperture;
wherein the apparatus is configured such that the position of the liquid capillary relative to the outlet aperture can be determined based on the flow rate measured by the flow meter.

The apparatus may comprise information indicative of a first flow rate, wherein the first flow rate is a flow rate that is indicative of the liquid capillary being in a first position relative to the outlet aperture.

The apparatus may be configured such that the position of the liquid capillary relative to the outlet aperture can be determined by comparing the measured flow rate to the first flow rate.

The first position may be a desired position of the liquid capillary relative to the outlet aperture, optionally wherein the first position is a position of the liquid capillary relative to the outlet aperture that corresponds to flow blurring nebulisation. The flow meter of the apparatus may be in accordance with any of the flow meters described herein. For example, the flow meter may be a mass flow meter such as a thermal mass flow meter or a Coriolis mass flow meter.

The apparatus may comprise a gas flow controller as described herein (such as a thermal mass flow controller) that comprises the flow meter.

The gas flow controller may be configured for adjusting the flow rate of gas to the outlet aperture based on a gas flow rate measured by the flow meter.

According to an aspect, there is provided an ion source comprising the nebuliser apparatus described above.

The ion source may comprise an Electrospray Ionisation (ESI) ion source, a Desorption Electrospray Ionisation (DESI) ion source, a Desorption Electro-Flow Focusing Ionisation (DEFFI) ion source, an impactor ion source, or an Atmospheric Pressure Chemical Ionisation (APCI) ion source.

According to an aspect, there is provided an analytical instrument comprising the ion source described above.

The analytical instrument may comprise a mass and/or ion mobility spectrometer.

### BRIEF DESCRIPTION OF THE DRAWINGS

Various embodiments will now be described, by way of example only, and with reference to the accompanying drawings in which:

FIG. 1A shows schematically an outlet end of a nebuliser in accordance an embodiment where a liquid capillary is in a relatively withdrawn position with respect to the nebuliser outlet, and FIG. 1B shows schematically an outlet end of a nebuliser in accordance with an embodiment where the liquid capillary is positioned closer to the nebuliser outlet;

FIG. 2A shows a simulation of gas velocity in a nebuliser where a liquid capillary is in a relatively withdrawn position with respect to the nebuliser outlet, and FIG. 2B shows a simulation of gas velocity in a nebuliser where the liquid capillary is positioned closer to the nebuliser outlet;

FIG. 3 shows schematically a nebuliser configured in accordance with an embodiment;

FIG. 4 shows plots of droplet size distribution for a nebuliser operated with different nebulising gas flow rates;

FIG. 5 shows plots of total ion current for a nebuliser operated with different nebulising gas pressures;

FIG. 6 shows gas flow simulations for a nebuliser where the position of the liquid capillary relative to the nebuliser outlet is varied;

FIG. 7 shows plots of total ion current for a nebuliser operated with different nebulising gas flow rates; and

FIG. 8A shows a plot of nebuliser gas flow rate with time during thermal stabilisation, and FIG. 8B shows a correspond plot of total ion current with time.

### DETAILED DESCRIPTION

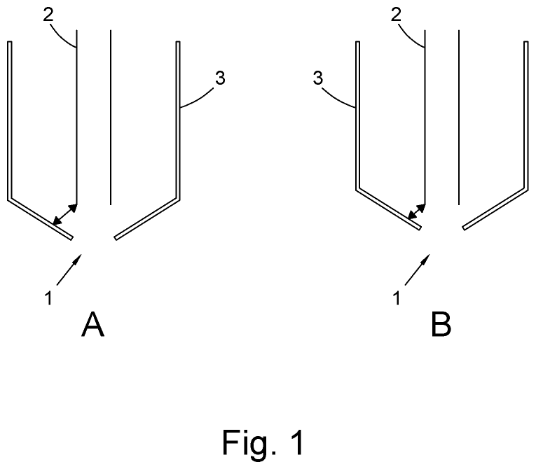

FIGS. 1A and 1B illustrate schematically part of a nebuliser in accordance with various embodiments.

The nebuliser may form part of an ion source, such as an Electrospray Ionisation (ESI) ion source. It would also be possible for the nebuliser to form part of another type of ion source that utilises a nebuliser, such as for example a Desorption Electrospray Ionisation (DESI) ion source, a Desorption Electro-Flow Focusing Ionisation (DEFFI), an impactor ion source, or an Atmospheric Pressure Chemical Ionisation (APCI) ion source.

The ion source may form part of or may be connectable to an analytical instrument, such as a mass and/or ion mobility spectrometer. Ions generated by the ion source may be analysed by the analytical instrument, e.g. so as to determine one or more physico-chemical properties of the ions, such as their mass, mass to charge ratio, ion mobility, etc.

As shown in FIGS. 1A and 1B, the nebuliser comprises an outlet orifice 1 and a liquid capillary 2. The outlet orifice 1 is formed at an outlet end of the nebuliser, i.e. in an outlet nozzle 3 of the nebuliser. The outlet nozzle 3 may have a central axis extending along its length, which may define an axial direction. A radial direction may extend outwardly from the central axis (may have the central axis as its origin).

The outlet aperture 1 may be arranged on (coaxial with) the central axis of the nebuliser outlet nozzle 3. The outlet aperture 1 may have any suitable size or inner diameter, such as a size or inner diameter of around (i) <200 μm; (ii) 200-250 μm; (iii) 250-300 μm; (iv) 300-350 μm; (v) 350-400 μm; or (vi) >400 μm.

The nebuliser is configured to emit a spray of droplets (generally in the axial direction, i.e. in a downward direction in FIGS. 1A and 1B), such as a spray of nebulised droplets, from its outlet aperture 1. To do this, the nebuliser may be configured to receive a flow of liquid and a flow of gas, and to cause the liquid to be nebulised by the gas so as to produce the spray of droplets.

The nebuliser may be configured to receive the flow of liquid via an inlet end of the liquid capillary 2, i.e. where the liquid capillary 2 is configured such that liquid provided to its inlet is emitted from its outlet end.

The flow of liquid received by the liquid capillary 2 may be a flow of solvent optionally containing analyte. The liquid may be provided to the liquid capillary 2 with a flow rate of, for example, (i) ≥100 μL/min; (ii) ≥200 μL/min; (iii) ≥300 μL/min; (iv) ≥400 μL/min; or (v) ≥500 μL/min. The flow of liquid may be, for example, an eluent from a liquid chromatography system. Thus, the nebuliser may be coupled to a liquid chromatography or other separation device. Alternatively, the flow of liquid may be from a (sample) reservoir.

The liquid capillary 2 may have any suitable configuration, such as for example, the configuration described in WO 2015/040384 (Micromass UK Ltd), the entire content of which is incorporated herein by reference.

The liquid capillary 2 may have any suitable inner diameter, such as an inner diameter of around (i) <100 μm; (ii) 100-150 μm; (iii) 150-200 μm; or (iv) >200 μm. The liquid capillary 2 may have any suitable outer diameter, such as an outer diameter of around (i) <200 μm; (ii) 200-250 μm; (iii) 250-300 μm; (iv) 300-350 μm; (v) 350-400 μm; or (vi) >400 μm. The outer diameter of the liquid capillary 2 may be approximately equal to, similar to, or larger than the size or inner diameter of the outlet aperture 1.

The liquid capillary 2 may be formed from an electrically conductive material such as a metal such as stainless steel. In embodiments, a voltage such as a high voltage may be applied to the liquid capillary 2, for example such that the spray of droplets emitted by the nebuliser comprises a spray of charged droplets, for example in the manner of an Electrospray Ionisation (ESI) ion source.

As shown in FIGS. 1A and 1B, the liquid capillary 2 may be arranged coaxially with respect to the outlet orifice 1 and/or the nozzle 3, e.g. along the central axis of the nozzle 3. The nozzle 3 may surround the liquid capillary 2 (in a concentric manner or otherwise). A (nebuliser) gas is provided to the nozzle 3, and passed through the nozzle 3 to the outlet aperture 1, such that the flow of liquid supplied to the liquid capillary 2 is nebulised by the nebulising gas. The gas may be any suitable nebulising gas such as for example nitrogen.

As also shown in FIGS. 1A and 1B, in particular embodiments, the liquid-emitting outlet of the liquid capillary 2 is withdrawn within (receded from) the outlet end of the nozzle 3. That is, the nebuliser may be configured such that the outlet (tip) of the liquid capillary 2 does not protrude beyond the outlet aperture 1, but is instead arranged within the nozzle 3 and withdrawn from the outlet aperture 1. This arrangement may be so as to produce so-called “flow blurring” nebulisation, i.e. where highly turbulent mixing between the liquid emitted from the capillary 2 and the nebulising gas flow creates a fine aerosol of extremely small droplets.

In these embodiments, the outlet of the liquid capillary 2 may be withdrawn from the outlet aperture 1 by any suitable distance, such as for example by around (i) 0-0.1 mm; (ii) 0.1-0.2 mm; (iii) 0.2-0.3 mm; (iv) 0.3-0.4 mm; (v) 0.4-0.5 mm; or (vi) >0.5 mm.

As described above, it has been found that the position of the liquid capillary 2 relative to the nebuliser outlet 1 can significantly affect the properties of the nebulised spray. In particular, the distance between the outlet of the liquid capillary 2 and the outlet aperture 1 (in the axial direction) can significantly affect the properties of the nebulised spray.

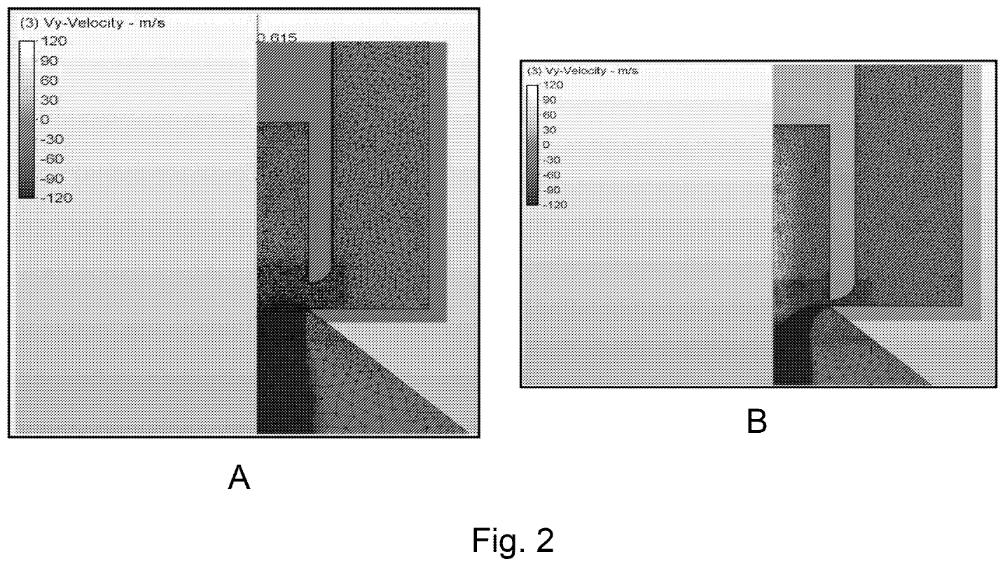

As illustrated by FIGS. 2A and 2B, this is particularly the case for flow blurring nebulisation, where it has been found that an optimum distance exists.

FIGS. 2A and 2B show the results of computational fluid dynamics (CFD) modelling of a flow blurring nebuliser. FIG. 2A shows results for an arrangement in which the liquid capillary 2 is in a relatively withdrawn position with respect to the nebuliser outlet 1, and FIG. 2B shows results for an arrangement in which the liquid capillary 2 is positioned closer to the nebuliser outlet 1.

As can be seen in FIGS. 2A and 2B, at certain capillary positions (i.e. the position shown in FIG. 2B), there is a component of the gas velocity (Vy) which is directed back up the capillary 2 (but this is not the case for all positions, such as the position shown in FIG. 2A). This back flow of gas helps to break up the liquid and form droplets before the liquid has left the capillary 2, and results in improved nebulisation and improved ionisation.

FIGS. 2A and 2B show that the capillary position relative to the outlet aperture 1 is an important parameter. It is therefore desirable to configure the nebuliser in such a way that the position of the liquid capillary 2 relative to the outlet aperture 1 is precisely controllable and reproducible.

Manufacturing imperfections (e.g. between different liquid capillaries and/or different nebuliser outlets, etc.), temperature changes, and so on, mean that it can be challenging to precisely set and maintain this distance using only the geometric properties of the nebuliser. In addition, in some embodiments, it can be desirable to be able to adjust the properties of the spray by operating the nebuliser with different capillary positions.

Therefore, the nebuliser may be configured such that the distance between the outlet of the capillary 2 and the outlet aperture 1 is adjustable (controllable), e.g. so that the properties of the spray that depend on this distance can be controlled (in use). This can allow the position can be set or optimised, e.g. during set-up of the analytical instrument and/or intermittently thereafter. The position could also be set or optimised before the ion source is connected to an instrument.

The nebuliser may be configured such that the distance between the outlet of the capillary 2 and the outlet aperture 1 is adjustable (controllable) in any suitable manner. For example, the nebuliser may include a mechanical arrangement, such as the mechanical arrangement described in GB 2562168 (Micromass UK Ltd), the contents of which are incorporated herein by reference, which may be configured to allow the distance between the outlet of the capillary 2 and the outlet aperture 1 to be adjusted. Other arrangements would, however, be possible.

GB 2549389 A1 describes optimising the position of the capillary 2 relative to the outlet aperture 1 during an experiment, by detecting ions using an analytical instrument, and adjusting the position using the mechanism until a maximum ion signal intensity is achieved.

However, measurements of ion signal intensity can depend on a number of factors that are unrelated to the position of the liquid capillary 2 relative to the outlet aperture 1. For example, that the ion signal intensity may be maximum at different positions where different ionic species are being measured, where the nebuliser is positioned and/or orientated differently with respect to an analytical instrument inlet, and so on. This in turn can make highly reproducible and precise control of the position challenging, in particular for inexperienced users, e.g. across different experiments and/or different instruments.

On the other hand, directly measuring the position of the liquid capillary relative to the nebuliser outlet, e.g. using a microscope, is a cumbersome, time-consuming and skilled task, that cannot be performed during an experiment, and that cannot be performed for flow blurring nebulisers, i.e. where the liquid capillary 2 is withdrawn inside the nebuliser nozzle 3.

In accordance various embodiments, the position of the liquid capillary relative to the nebuliser outlet is measured indirectly by measuring the flow rate of the nebulising gas supplied to the nebuliser outlet.

Referring again to FIGS. 1A and 1B, FIG. 1A shows the liquid capillary 2 in a relatively withdrawn position, whereas FIG. 1B shows the liquid capillary 2 in a position closer to the outlet orifice 1. As can be seen from FIGS. 1A and 1B, the inner wall of the nebuliser nozzle 3 and the liquid capillary 2 effectively form a gas restriction inside the nebuliser. This restriction is indicated by the double headed arrows in FIGS. 1A and 1B. The gas restriction becomes greater as the capillary 2 moves closer to the aperture 1. This means that the gas flow through the nebuliser will change as the capillary 2 is moved in the axial direction (provided that the inner wall of the nebuliser and the liquid capillary 2 are primarily responsible for restricting the gas flow).

Therefore, flow rate measurements can be used as a proxy for measurements of the position of the liquid capillary relative to the nebuliser outlet aperture. Such measurements are independent of factors that are unrelated to the position, such as of the particular sample being analysed, other parameters of the nebuliser and/or the ion source, the configuration of the analytical instrument, and so on.

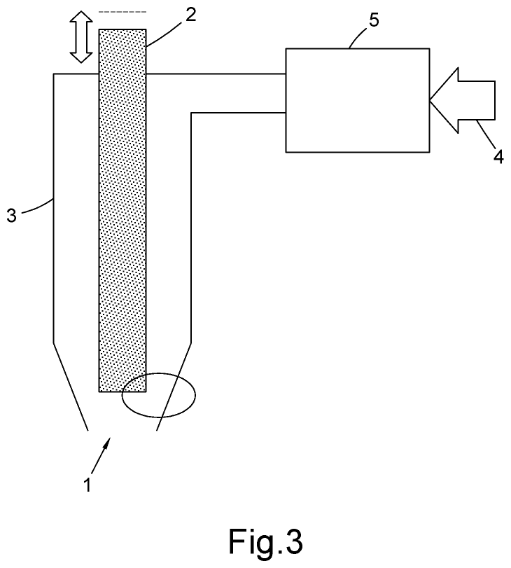

FIG. 3 shows nebuliser apparatus configured in accordance with various embodiments. The nebuliser of FIG. 3 is similar to the nebuliser described above with respect to FIGS. 1A and 1B, i.e. comprises an outlet aperture 1, and a liquid capillary 2 arranged within a nozzle 3. A gas flow restriction occurs where the capillary 2 meets the nebuliser inner wall. As is indicated by the double headed arrow in FIG. 3, the vertical position of the liquid capillary 2 relative to the outlet aperture 1 is adjustable.

The nebuliser apparatus also comprises a gas supply 4 configured to supply gas, such as nitrogen, to the outlet aperture 2 via the nozzle 3. The gas supply 4 may be configured to supply gas to the outlet aperture 2 at selected, fixed pressure. The gas supply 4 may be configured such that the pressure at which gas is supplied can be adjusted. The nebulising gas may be provided at a pressure between about 1 and 10 bar, such as between about 2 and 7 bar, such as between about 3 and 5 bar, such as about 4 bar.

In accordance with various embodiments, the nebuliser apparatus further comprises a flow meter 5, such as a mass flow meter, which is configured to measure the flow rate of the gas supplied to the nebuliser (i.e. to the outlet aperture 1 via the nozzle 3).

In accordance with embodiments, gas is supplied to the outlet aperture 1 from the gas supply 4 at a selected, fixed pressure, and the flow meter 5 is used to measure the flow rate of the gas. The position of the liquid capillary 2 relative to the outlet aperture 1 is then determined based on the measured flow rate. In particular, the distance between the outlet of the liquid capillary 2 and the outlet aperture 1 in the axial direction (that extends along the length of the nebuliser 3 and/or along the length of the liquid capillary 2) is determined based on the measured flow rate.

The measured flow rate can be used to determine a precise numerical value of the position, or merely to determine whether or not the position is as desired. A desired position may correspond to an optimum position, e.g. for flow blurring as described above. A desired position may also or instead correspond to an optimum position for a given compound, molecule or molecules being analysed, and/or an optimum position for a given liquid chromatography solvent composition such as a given water to acetonitrile (ACN) ratio, and the like.

Thus, in embodiments the flow rate is used to determine either that (i) the liquid capillary 2 has a desired position relative to the outlet aperture 1; or that (ii) the liquid capillary 2 has an undesired position relative to the outlet aperture 1. This determination may be made by comparing the measured flow rate to information indicative of one or more desired flow rates, where each desired flow rate is indicative of the capillary 2 being in a desired position (in respect of a particular gas pressure). When the measured flow rate corresponds to a desired flow rate, it may be determined that the liquid capillary 2 has a desired position relative to the outlet aperture 1.

When the measured flow rate does not correspond to a desired flow rate, it may be determined that the liquid capillary 2 has an undesired position relative to the outlet aperture 1. In this case, the position of the liquid capillary 2 relative to the outlet aperture 1 may then be altered, for example using the mechanism described above.

Thus, in embodiments, the position of the liquid capillary 2 relative to the outlet aperture 1 is adjusted based on the measured flow rate, e.g. when the measured flow rate does not correspond to a desired flow rate. This may comprise altering the distance between the outlet of the liquid capillary 2 and the outlet aperture 1 in the axial direction that extends along the length of the nebuliser 3 and/or along the length of the liquid capillary 2.

More particularly, the flow rate may be used to determine one of (i) the distance between the outlet of the liquid capillary 2 and the outlet aperture 1 is greater than desired (when the measured flow rate is greater than a desired flow rate); (ii) the distance between the outlet of the liquid capillary 2 and the outlet aperture 1 is less than desired (when the measured flow rate is less than the desired flow rate); and (iii) the distance between the outlet of the liquid capillary 2 and the outlet aperture 1 is as desired (when the measured flow rate corresponds to the desired flow rate).

Then, when it is determined, based on the measured flow rate, that the distance between the outlet of the liquid capillary 2 and the outlet aperture 1 is greater than desired, the distance between the outlet of the liquid capillary 2 and the outlet aperture 1 may be reduced. When it is determined, based on the measured flow rate, that the distance between the outlet of the liquid capillary 2 and the outlet aperture 1 is less than desired, the distance between the outlet of the liquid capillary and the outlet aperture may be increased.

It will be appreciated that the use of a flow rate measurement to determine and set the position of the liquid capillary 2 relative to the outlet aperture 1 is a relatively straightforward task that can be accomplished by an inexperienced user, and so is particularly suited for use as part of a standard operating procedure defined for the ion source.

In embodiments, information indicative of one or more desired flow rates (e.g. a set of flow rates) is provided, e.g. for use as part of a standard operating procedure to configure the nebuliser. The information may be stored in a (memory of a) control system of the nebuliser apparatus and/or analytical instrument, or may be provided together with the apparatus in some other way, e.g. as part of a set of operating instructions, e.g. in an operating manual or otherwise.

Each desired flow rate of the set may be indicative of the capillary 2 being in a desired positon relative to the outlet aperture 1 when gas is supplied to the outlet 1 at a particular pressure. The information may include different desired flow rates in respect of different desired positions. Equally, the information may include different desired flow rates in respect of different gas pressures (e.g. where each of the different desired flow rates is indicative of the capillary 2 being in the same desired positon relative to the outlet aperture 1, for each of the different pressures).

Thus, the capillary 2 may be set to a desired position by supplying the gas to the outlet aperture with particular pressure, comparing the measured flow rate to a desired flow rate that is indicative of the capillary being in the desired position with respect to that gas pressure, and then adjusting the distance if needed (as described above) until the measured flow rate corresponds to the desired flow rate.

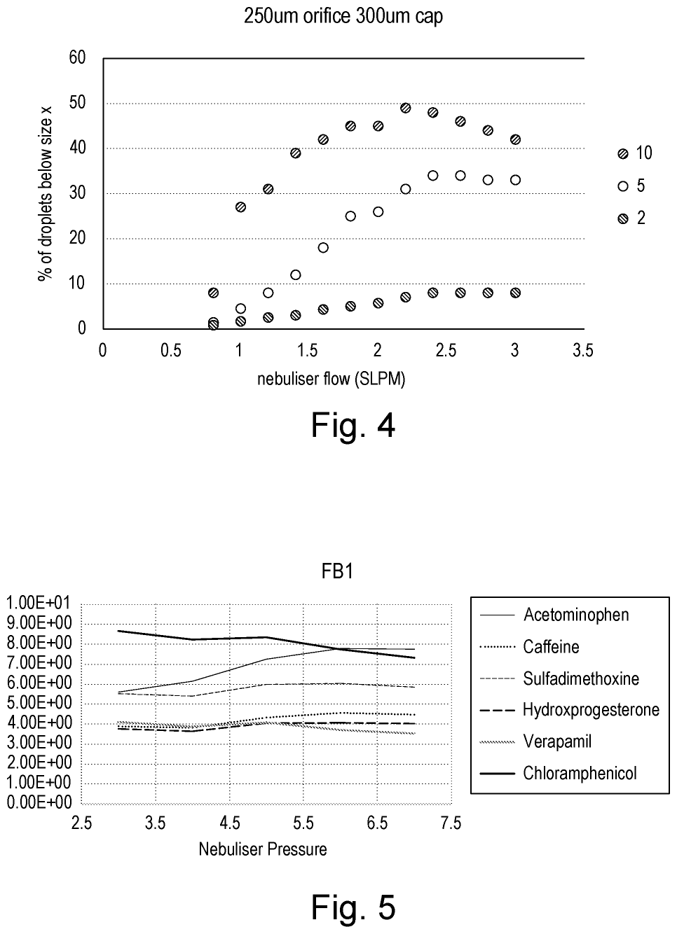

FIG. 4 shows measured droplet size distribution for a nebuliser with a 250 μm orifice 1 and a 300 μm outer diameter liquid capillary 2. As can be seen in FIG. 4, the droplet size distribution (in particular, the percentage of droplets produced by the nebuliser having sizes (diameters) below 10 μm, 5 μm, and 2 μm) varies when the nebuliser gas flow rate is varied. In general, the droplet size distribution is improved (i.e. smaller droplets are produced) as the capillary 2 is adjusted to increase the nebuliser flow rate. However, it can be desirable to produce small droplets using the least amount of gas to aid desolvation of the droplets.

FIG. 5 shows total ion current for various different samples measured using an ESI ion source, where the pressure of the nebulising gas provided to the nebuliser was varied. It can be seen from FIG. 5 that the performance is relatively flat with respect to nebuliser pressure (which would change the nebuliser flow, without changing the capillary position). Therefore, the gas flow rate through the nebuliser is only important as a proxy for the position of the capillary.

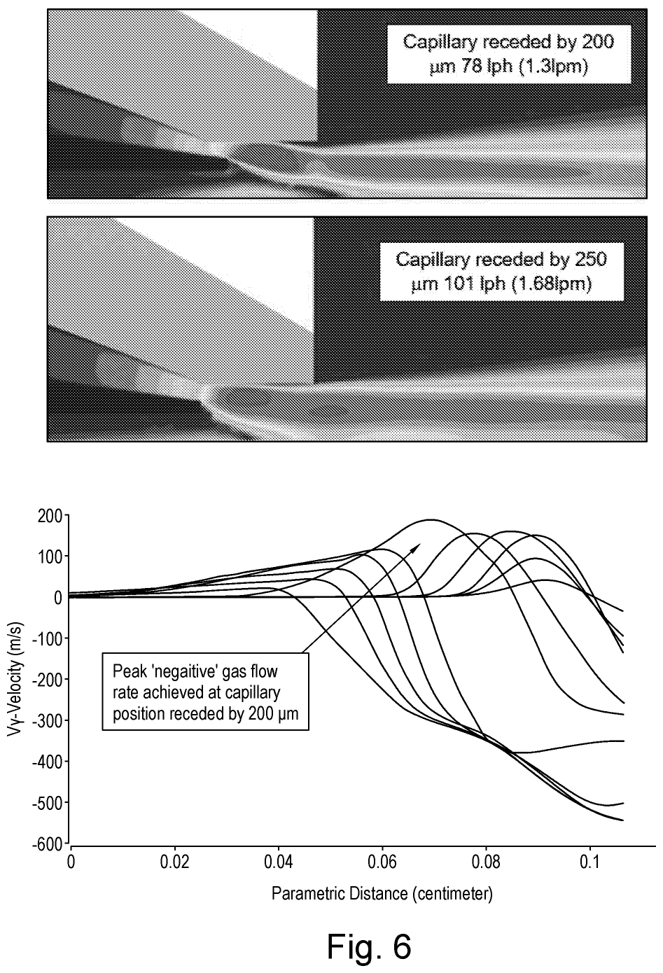

FIG. 6 shows the result of a simulation to confirm that the optimum capillary positions determined on instrument correspond to conditions for flow blurring (as described above with respect to FIG. 2). The optimum position was found to have a gas flow rate of 1.3 lpm (at 4 bar), which was found to correspond to a capillary position of 200 μm recessed.

Plotting out the ‘backwards’ or negative gas flow rate as a function of capillary position confirmed that it reached a maxima at the experimentally determined position. In addition the flow was choked, which ties in with the insensitivity to nebuliser pressure shown in FIG. 5.

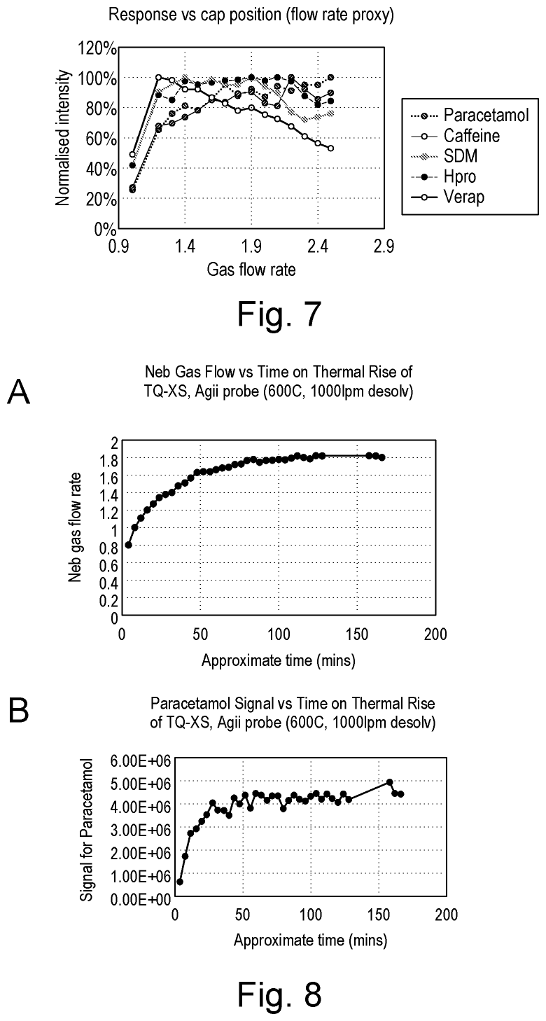

FIG. 7 shows total ion current for various different samples measured using an ESI ion source, where the flow rate of the nebulising gas provided to the nebuliser was varied. It can be seen from FIG. 7 that different compounds optimise at slightly different flow rates, and hence slightly different capillary positions. Therefore, in embodiments, the information indicative of one or more desired flow rates can optionally include different desired flow rates in respect of different compounds, i.e. so that the position can be set to an optimum position depending on the particular compound being analysed.

It would also be possible for the information to include different desired flow rates in respect of one or more other variables, such as for example different liquid chromatography solvent compositions (such as a different water to acetonitrile (ACN) ratios), and the like, i.e. so that the position can be set to an optimum position depending on the particular value(s) of the variable(s).

As can also be seen from FIG. 7, the positional changes indicated by the changes in flow rate are of the order of tens of microns, which corresponds to a tolerance which would be too tight to be fixed in an assembly.

FIG. 8A shows how the measured flow can change with time due to thermal stabilisation of the ions source, and FIG. 8B illustrates the corresponding stabilisation of the measured ion signal. As can be seen from FIGS. 8A and 8B, the settling of the flow rate with temperature corresponds to the settling of the instrument response. Thus, in addition to straightforwardly setting a mechanically sensitive position, measurements of the flow through the nebuliser can provide a method of determining whether the ion source is thermally stable.

Although the present invention has been described with reference to preferred embodiments, it will be understood by those skilled in the art that various changes in form and detail may be made without departing from the scope of the invention as set forth in the accompanying claims.

1. A method of operating a nebuliser that comprises an outlet aperture and a liquid capillary, the method comprising:
supplying a gas to the outlet aperture;
measuring a flow rate of the gas supplied to the outlet aperture; and
determining a position of the liquid capillary relative to the outlet aperture based on the measured flow rate.

2. The method of claim 1, wherein determining the position of the liquid capillary relative to the outlet aperture based on the measured flow rate comprises:
determining, based on the measured flow rate, a distance between an outlet of the liquid capillary and the outlet aperture in an axial direction that extends along a length of the nebuliser and/or along a length of the liquid capillary.

3. The method of claim 1 or 2, wherein determining the position of the liquid capillary relative to the outlet aperture based on the measured flow rate comprises:
determining, based on the measured flow rate, either that (i) the liquid capillary is in a first position relative to the outlet aperture; or that (ii) the liquid capillary is other than in the first position relative to the outlet aperture.

4. The method of any one of the preceding claims, wherein the method comprises:
supplying the gas to the outlet aperture at a first pressure;
comparing the measured flow rate to a first flow rate, wherein the first flow rate is a flow rate that is indicative of the liquid capillary being in a first position relative to the outlet aperture when gas is supplied to the outlet aperture at the first pressure; and
determining that the liquid capillary is in the first position when the measured flow rate is approximately equal to the first flow rate; and/or
determining that the liquid capillary is other than in the first position when the measured flow rate is unequal to the first flow rate.

5. The method of claim 3 or 4, wherein the first position is a desired position of the liquid capillary relative to the outlet aperture.

6. The method of claim 3, 4, or 5, wherein the first position is a position of the liquid capillary relative to the outlet aperture that corresponds to flow blurring nebulisation.

7. The method of any one of claims 3 to 6, further comprising:
when it is determined, based on the measured flow rate, that the liquid capillary is other than in the first position, altering the position of the liquid capillary relative to the outlet aperture.

8. A method of operating a nebuliser that comprises an outlet aperture and a liquid capillary, the method comprising:
supplying a gas to the outlet aperture;
measuring a flow rate of the gas supplied to the outlet aperture; and
altering the position of the liquid capillary relative to the outlet aperture based on the measured flow rate.

9. The method of claim 7 or 8, wherein altering the position of the liquid capillary relative to the outlet aperture comprises:
altering a distance between an outlet of the liquid capillary and the outlet aperture in an axial direction that extends along a length of the nebuliser and/or along a length of the liquid capillary.

10. The method of claim 2 or 9, comprising:
determining that the distance between the outlet of the liquid capillary and the outlet aperture is greater than a first distance when the measured flow rate is greater than a first flow rate; and/or
determining that the distance between the outlet of the liquid capillary and the outlet aperture is less than the first distance when the measured flow rate is less than the first flow rate; and/or
determining that the distance between the outlet of the liquid capillary and the outlet aperture is approximately equal to the first distance when the measured flow rate approximately equal to the first flow rate.

11. The method of claim 10, further comprising:
when it is determined, based on the measured flow rate, that the distance between the outlet of the liquid capillary and the outlet aperture is greater than the first distance, reducing the distance between the outlet of the liquid capillary and the outlet aperture; and/or
when it is determined, based on the measured flow rate, that the distance between the outlet of the liquid capillary and the outlet aperture is less than the first distance, increasing the distance between the outlet of the liquid capillary and the outlet aperture.

12. The method of any one of the preceding claims, wherein determining the position of the liquid capillary relative to the outlet aperture comprises determining, based on the measured flow rate, whether the position of the liquid capillary relative to the outlet aperture is stable.

13. The method of any one of the preceding claims, wherein the nebuliser is configured such that an outlet of the liquid capillary is withdrawn within the nebuliser and/or other than protrudes beyond the outlet aperture

14. The method of any one of the preceding claims, further comprising:
supplying a liquid to the liquid capillary and nebulising the liquid using the nebuliser; and
optionally ionising the liquid.

15. A method of mass and/or ion mobility spectrometry, the method comprising producing ions by ionising a liquid sample using the method of claim 14, and analysing the ions.

16. The method of any preceding claim, comprising providing a gas flow controller having a gas flow meter, wherein said step of measuring the flow rate of the gas supplied to the outlet aperture comprises measuring the flow rate of the gas using the gas flow meter, and wherein the gas flow controller adjusts the flow rate of gas to the outlet aperture based on a gas flow rate measured by the gas flow meter.

17. A nebuliser apparatus comprising:
a nebuliser comprising an outlet aperture and a liquid capillary, wherein the nebuliser is configured such that an outlet of the liquid capillary is withdrawn within the nebuliser, and wherein the apparatus is configured such that the position of the liquid capillary relative to the outlet aperture can be altered;
a gas supply configured to supply gas to the outlet aperture; and
a flow meter configured to measure a flow rate of the gas supplied to the outlet aperture;
wherein the apparatus is configured such that the position of the liquid capillary relative to the outlet aperture can be determined based on the flow rate measured by the flow meter.

18. The apparatus of claim 17, further comprising information indicative of a first flow rate, wherein the first flow rate is a flow rate that is indicative of the liquid capillary being in a first position relative to the outlet aperture;
wherein the apparatus is configured such that the position of the liquid capillary relative to the outlet aperture can be determined by comparing the measured flow rate to the first flow rate.

19. The apparatus of claim 18, wherein the first position is a desired position of the liquid capillary relative to the outlet aperture, optionally wherein the first position is a position of the liquid capillary relative to the outlet aperture that corresponds to flow blurring nebulisation.

20. The apparatus of claim 17, 18 or 19, comprising a gas flow controller that comprises the flow meter, wherein the gas flow controller is configured for adjusting the flow rate of gas to the outlet aperture based on a gas flow rate measured by the flow meter.

21. An ion source comprising the nebuliser apparatus of claim 18, 19 or 20, optionally wherein the ion source comprises an Electrospray Ionisation (ESI) ion source, a Desorption Electrospray Ionisation (DESI) ion source, a Desorption Electro-Flow Focusing Ionisation (DEFFI) ion source, an impactor ion source, or an Atmospheric Pressure Chemical Ionisation (APCI) ion source.

22. An analytical instrument comprising the ion source of claim 21, optionally wherein the analytical instrument comprises a mass and/or ion mobility spectrometer.
